(19) United States
(12) Patent Application Publication
(10) Pub. No.: US 2018/0020709 A1
(43) Pub. Date: Jan. 25, 2018

(54) REBAUDIOSIDE M BIOSYNTHETIC PRODUCTION AND RECOVERY METHODS

(71) Applicant: PureCircle USA Inc., Oak Brook, IL (US)

(72) Inventor: Avetik MARKOSYAN, Yerevan (AM)

(21) Appl. No.: 15/550,075

(22) PCT Filed: Feb. 10, 2016
(86) PCT No.: PCT/US16/17236

§ 371 Date: Aug. 10, 2017

Related U.S. Application Data
(63) Continuation-in-part of application No. 14/254,653, filed on Apr. 16, 2014, now Pat. No. 9,386,797.
(60) Provisional application No. 62/114,134, filed on Feb. 10, 2015.

(51) Int. Cl. A23L 27/30; A23L 2/60; A21D 13/40; A23L 2/02; A23L 2/54

(52) U.S. Cl. CPC A23L 27/36; A23L 2/02; A23L 2/54; A21D 13/40; A23L 2/60; A23V 2002/00

(57) ABSTRACT

Various recovery processes are provided for the complete recovery of low soluble steviol glycosides obtained in recombinant microorganisms. Soluble α-glycosyl steviol glycosides were fully recovered in downstream processing and then converted to steviol glycosides by hydrolases. The obtained steviol glycosides were purified and used as sweeteners, sweetness enhancers, flavor enhancers, and flavor modifiers in foods, beverages, cosmetics and pharmaceuticals.

### RELATED APPLICATIONS

This application incorporates by reference U.S. patent application Ser. No. 14/254,653, filed on Apr. 16, 2014, and published as US 2014/0227421 on Aug. 14, 2014, in its entirety.

### BACKGROUND OF THE INVENTION

### Field of the Invention

The invention relates to a process for producing terpenoid glycosides by recombinant microorganisms and recovering the produced glycosides for use in various food products and beverages.

### Description of the Related Art

Nowadays sugar alternatives are receiving increasing attention due to awareness of many diseases in conjunction with consumption of high-sugar foods and beverages. However many artificial sweeteners such as dulcin, sodium cyclamate and saccharin were banned or restricted in some countries due to concerns on their safety. Therefore non-caloric sweeteners of natural origin are becoming increasingly popular. The sweet herb Stevia rebaudiana Bertoni, produces a number of diterpene glycosides which feature high intensity sweetness and sensory properties superior to those of many other high potency sweeteners.

The above-mentioned sweet glycosides, have a common aglycon, steviol, and differ by the number and type of carbohydrate residues at the C13 and C19 positions. The leaves of Stevia are able to accumulate up to 10-20% (on dry weight basis) steviol glycosides. The major glycosides found in Stevia leaves are Rebaudioside A (2-10%), Stevioside (2-10%), and Rebaudioside C (1-2%). Other glycosides such as Rebaudioside B, D, E, F, G, H, K, L, M, N, and O, Steviolbioside, Dulcoside A and Rubusoside are found at lower levels (approx. 0-0.5%).

Two major glycosides—Stevioside and Rebaudioside A, were extensively studied and characterized in terms of their suitability as commercial high intensity sweeteners. Stability studies in carbonated beverages confirmed their heat and pH stability (Chang S. S., Cook, J. M. (1983) Stability studies of stevioside and Rebaudioside A in carbonated beverages. J. Agric. Food Chem. 31: 409-412.)

Steviol glycosides differ from each other not only by molecular structure, but also by their taste properties. Usually stevioside is found to be 110-270 times sweeter than sucrose, Rebaudioside A between 150 and 320 times, and Rebaudioside C between 40-60 times sweeter than sucrose. Dulcoside A is 30 times sweeter than sucrose. Rebaudioside A has the least astringent, the least bitter, and the least persistent aftertaste thus possessing the most favorable sensory attributes in major steviol glycosides (Tanaka O. (1987) Improvement of taste of natural sweeteners. Pure Appl. Chem. 69:675-683; Phillips K. C. (1989) Stevia: steps in developing a new sweetener. In: Grenby T. H. ed. Developments in sweeteners, vol. 3. Elsevier Applied Science, London. 1-43.)

Rebaudioside M, (also known as Rebaudioside X; CAS No: 1220616-44-3) is one of minor steviol glycosides found in Stevia rebaudiana plant. It was found to have superior taste properties and is a highly desirable natural high intensity sweetener (WO2013/096420 007748 incorporated herein as a reference, in its entirety).

Due to low concentration in Stevia leaves, number of biocatalytic methods for producing minor steviol glycosides (including Rebaudioside M) by enzymes and recombinant hosts were described (WO2013/176738, WO2014/122328, WO2015/007748 incorporated herein as references, in their entireties).

When producing Rebaudioside M in recombinant microorganism, one will be aiming to achieve the highest concentration/titer of Rebaudioside M (Reb M). For recombinant microorganism production of different compounds the commercial feasibility generally starts at titers above 10 g/L. On the other hand it is known that Reb M has limited solubility in the water of about 1 g/L (US2015/0017284 incorporated herein as a reference, in its entirety). Thus in recombinant microorganism production of Reb Mat concentrations above 1 g/L the Reb M will precipitate/crystallize from media.

Usually after fermentation of recombinant microorganisms one of the first steps of downstream processing is the removal of microbial cells or cell debris. This can be achieved by any method known to art, including, but not limited to, centrifugation, decanting, filtration etc. As a result a sludge of microbial cells (cell debris), and a clear solution of dissolved product are obtained. The solution is processed further downstream for product recovery while the sludge is disposed off after sterilization. Due to limited solubility of Reb M, it crystallizes and during downstream processing significant amount of Reb M crystals are lost with the separated biomass/sludge during cell (cell debris) removal process. This reduces the efficiency of the entire process and makes it less commercially viable.

Therefore it is necessary to develop simple process for producing Reb M by recombinant microorganisms which will feature highly efficient recovery mechanism(s).

### BRIEF DESCRIPTION OF THE DRAWINGS

The accompanying drawings are included to provide a further understanding of the invention. The drawings illustrate embodiments of the invention and together with the description serve to explain the principles of the embodiments of the invention.

FIG. 1 shows a high-performance liquid chromatographic (HPLC) chromatogram of Rebaudioside M;

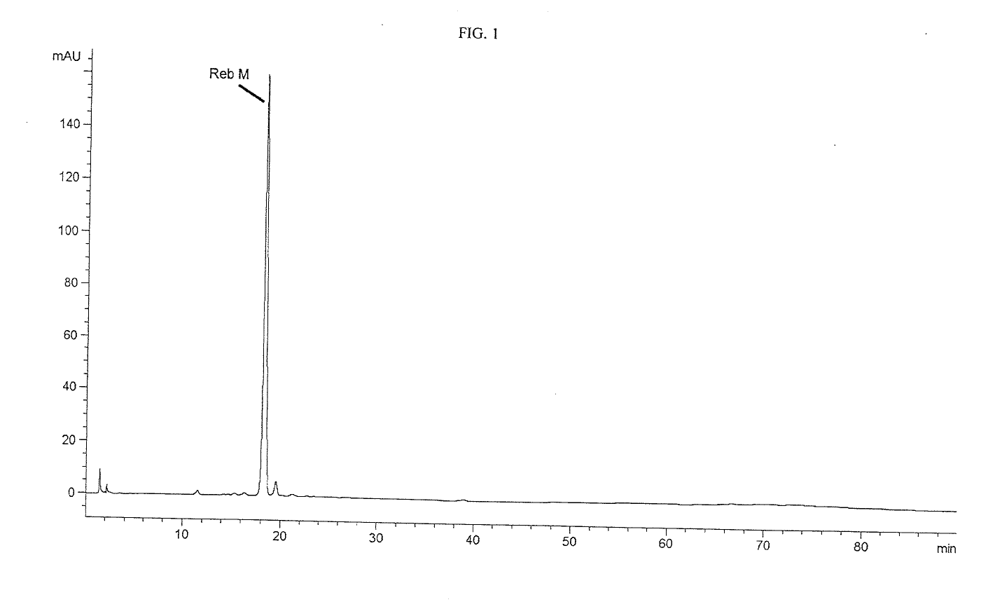

FIG. 2 shows a HPLC chromatogram of α-glycosylated Rebaudioside M containing α-1,4-glucosyl-derivatives of Rebaudioside M;

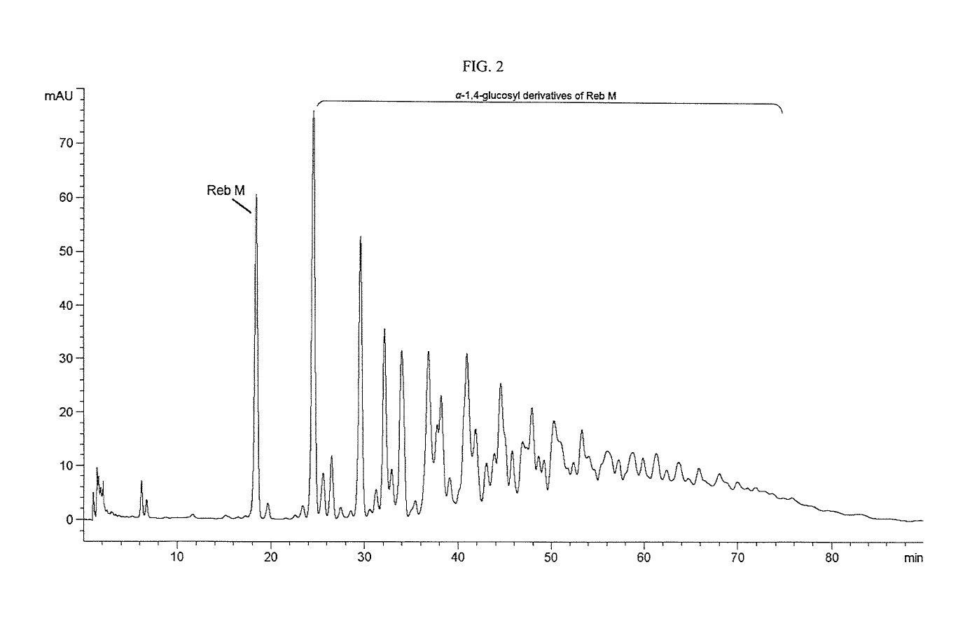

FIG. 3 shows a HPLC chromatogram of glucoamylase treated α-1,4-glucosyl-derivatives of Rebaudioside M.

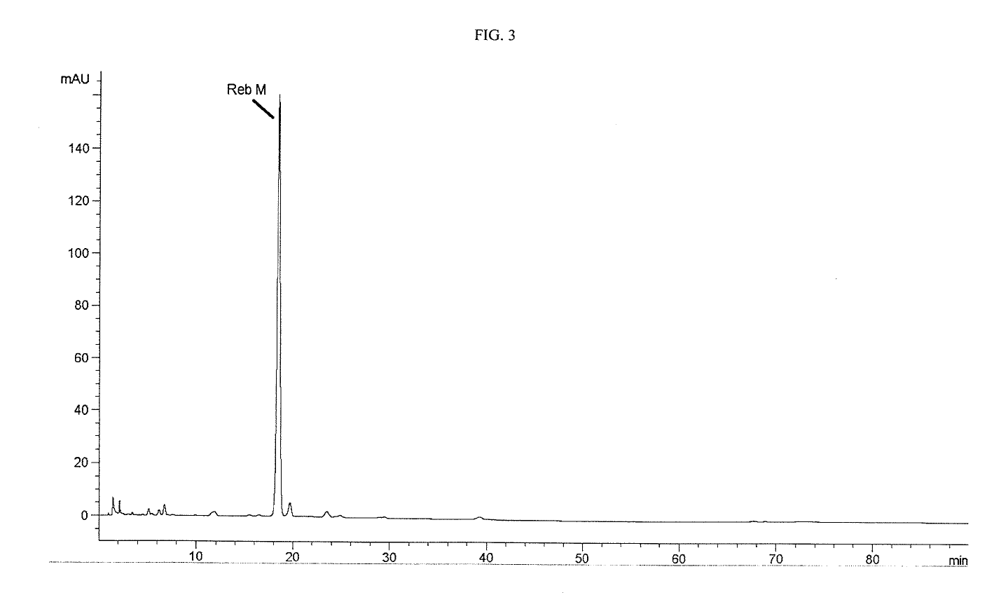

### DETAILED DESCRIPTION OF THE INVENTION

Advantages of the present invention will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

It also should be understood that the described methods could be applied to any known glycoside of steviol or terpenoid glycoside.

The HPLC analysis of the raw materials and products was performed on Agilent Technologies 1200 Series (USA) liquid chromarograph, equipped with Zorbax-NH₂ (4.6×250 mm) column. The mobile phase was acetonitrile-water gradient from 80:20, v/v (0-2 min) to 50:50, v/v (2-90 min). A diode array detector set at 210 nm was used as the detector.

The present invention is aimed to overcome the disadvantages of existing processes for producing steviol glycoside(s) found in Stevia rebaudiana plant by recombinant microorganism(s). The invention relates to a process for producing steviol glycoside(s) found in Stevia rebaudiana plant by recombinant microorganism(s) and recovering the produced glycoside(s) for use in various food products and beverages as sweetener, sweetness enhancer, flavor, flavor modifier/enhancer.

The steviol glycosides are selected from the group consisting of stevioside, Rebaudioside A, Rebaudioside B, Rebaudioside C, Rebaudioside D, Rebaudioside E, Rebaudioside F, Rebaudioside G, Rebaudioside H, Rebaudioside I, Rebaudioside J, Rebaudioside K, Rebaudioside L, Rebaudioside M, Rebaudioside N, Rebaudioside O, dulcoside A, steviolbioside, rubusoside, steviolmonoside, as well as any other steviol glycoside(s) found in Stevia rebaudiana plant, and mixtures thereof.

The invention, in part, pertains to a process of producing steviol glycosides found in Stevia rebaudiana plant by fermentation of recombinant microorganism(s).

The process of invention, may further include a step of adding alcohol to the fermentation media of recombinant microorganism(s) resulting in better dissolution of steviol glycosides.

The process of invention, may include a step of adding solvent comprising alcohol to any media obtainable from downstream processing of fermentation media of recombinant host(s). In one embodiment said media comprises separated recombinant microorganism(s) cells (cell debris) and crystalline steviol glycosides.

The alcohol may be selected from the group including but not limited to methanol, ethanol, n-propanol, iso-propanol, n-butanol, iso-butanol, and combinations thereof. The alcohol may be in a form of aqueous solution or anhydrous.

The process of invention, may include a step of producing α-glycosylated derivatives of steviol glycosides found in Stevia rebaudiana plant wherein said α-glycosylated derivatives contain at least one αα-glycosyl residue in their molecule.

The process of invention, may include a further step of selective hydrolysis of α-glycosydic bond(s) to convert α-glycosylated derivatives of steviol glycosides to steviol glycosides found in Stevia rebaudiana plant.

The invention, in part, pertains to a composition comprising α-glycosylated derivatives of steviol glycosides found in Stevia rebaudiana plant.

The invention, in part, pertains to a process for producing a composition comprising α-glycosylated forms of stevioside, Rebaudioside A, Rebaudioside B, Rebaudioside C, Rebaudioside D, Rebaudioside E, Rebaudioside F, Rebaudioside G, Rebaudioside H, Rebaudioside I, Rebaudioside J, Rebaudioside K, Rebaudioside L, Rebaudioside M, Rebaudioside N, Rebaudioside O, dulcoside A, steviolbioside, rubusoside, steviolmonoside as well as any other steviol glycoside(s) found in Stevia rebaudiana plant, and mixtures thereof.

In one embodiment the process comprises an enzymatic α-glycosylation step. The α-glycosylation step can occur within the recombinant host cell, on the surface of the recombinant host cell, or outside the recombinant host cell.

In one embodiment the α-glycosylation is achieved by using transglycosidase(s) and carbohydrate donors. Non-limiting examples of carbohydrate donor include starch, maltodextrins, corn syrup solids, cyclodextrins, sucrose, maltose, maltooligosaccharides, fructooligosaccharides, inulin, inulooligosaccharides, xylooligosaccharides, coupling sugar, lactose and combinations thereof.

In another embodiment the α-glycosylation is achieved by α-glycosyltransferase(s) and nucleotide glycosyl donor.

In yet another embodiment the α-glycosylation is achieved by α-glycosyltransferase(s) and non-nucleotide glycosyl donor.

In one embodiment cyclomaltodextrin glucanotransferase (CGTase; EC 2.4.1.19) enzyme(s) and starch (as glucose donor) were used to produce α-1,4-glucosyl-derivatives of steviol glycosides containing at least one α-1,4-glucosyl residue in their molecules.

Other enzymes and glycosyl residue donors may be used to produce α-glycosyl-derivatives of steviol glycosides containing at least one α-1,1-glycosyl residue, at least one α-1,2-glycosyl residue, at least one α-1,3-glycosyl residue, at least one α-1,4-glycosyl residue, at least one α-1,5-glycosyl residue, at least one α-1,6-glycosyl residue in their molecules. The enzymes can be in a form of cell-free culture broth, concentrated liquid cell-free culture broth, spray dried or freeze dried cell-free culture broth, or high purity protein. Free and immobilized enzyme preparations can be used. The enzyme(s) for α-glycosyl-derivatives synthesis may be also incorporated into the recombinant microorganism capable of producing steviol glycosides molecules found in Stevia rebaudiana plant.

In one embodiment the enzyme(s) for α-glycosyl-derivatives synthesis may be also incorporated into any recombinant host capable of producing steviol glycosides molecules found in Stevia rebaudiana plant.

The obtained α-glycosyl-derivatives have higher water solubility and hence do not precipitate. Thus the microbial cells (cell debris) removal results in no or minimal loss of product.

In one embodiment after the separation of the microbial cells (cell debris) the α-1,4-glucosyl-derivatives dissolved in supernatant are hydrolyzed by glucoamylase for selective hydrolysis of α-1,4-glycosidic bonds and conversion of α-1,4-glucosylated derivatives of steviol glycosides to steviol glycosides molecules found in Stevia rebaudiana plant.

Other enzymes capable of hydrolyzing α-1,4-glycosidic bonds can be used as well. The enzyme can be in a form of cell-free culture broth, concentrated liquid cell-free culture broth, spray dried or freeze dried cell-free culture broth, or high purity protein. Free and immobilized enzyme preparations can be used.

In one embodiment the transglucosylation was accomplished by CGTase of Bacillus stearothermophilus St-100 (PureCircle Sdn Bhd Collection of Industrial Microorganisms—Malaysia).

The activity of CGTase preparations was determined according to the procedure described in Hale W. S., Rawlins L. C. (1951) Amylase of Bacillus macerans. Cereal Chem. 28, 49-58.

Starches of different origin may be used as donors of glucosyl units such as, derived from wheat, corn, potato, tapioca, and sago. Alternatively other donors of glucosyl residues such as maltodextrins, cyclodextrins etc may be used as well.

Starch was subjected to partial hydrolysis (liquefaction) prior to the transglycosylation reaction. The dextrose equivalent of the partially hydrolyzed starch can be in the range of about 10-25, preferably about 12-16. Any enzyme capable of starch hydrolysis may be used for liquefaction, such as α-amylases, β-amylases etc. In one embodiment, CGTase and a-amylase mixtures as liquefying enzymes are preferred.

Upon completion of Reb M transglucosylation reaction, about 0.5-1.0 units of glucoamylase (AMG300L, Novozymes), per gram of solids, was added and the reaction was continued for about 12-16 hours at about 45-65° C., preferably about 60° C.

One unit of glucoamylase activity is defined as the amount of glucoamylase that will liberate 0.1 mol/min of p-nitrophenol from the PNPG Solution under the conditions of the assay described in Food Chemicals Codex 5^{th} ed., p. 907.

The reaction is stopped by heating at about 95° C. for about 15 minutes to inactivate the enzyme(s), and the solution may be treated with activated carbon and/or desalted by passing through ion exchange resins. Other appropriate decolorizing and desalting methods, such as membrane filtration, or other methods known in the art can be used.

The reaction mixture may be further concentrated by vacuum evaporator and/or dried by means of a spray dryer. Other appropriate concentrating and drying methods, such as membrane filtration, freeze drying, or other methods known to art can be used.

The steviol glycosides from obtained reaction mixture may be recovered by any method or combination of methods known to art for extraction, separation, purification, isolation and production of steviol glycosides found in Stevia rebaudiana plant. Non limiting examples of such methods include extraction by water and or organic solvents, treatment with flocculants, coagulants, treatment with macroporous adsorption resins, ion-exchange resin treatment, activated carbon treatment, membrane filtration, RO-membrane filtration, microfiltration, nanofiltration, ultrafiltration, chromatography, HPLC, SMB-chromatography, supercritical fluid (SF) chromatography, adsorption resin chromatography, multicolumn adsorption chromatography, ion-exchange chromatography, continuous chromatography, supercritical fluid extraction, ultrasound assisted extraction, microwave assisted extraction, enzyme assisted extraction, solid-liquid extraction, liquid-liquid extraction, crystallization, ultrasound assisted crystallization, gradient crystallization, solvent-antisolvent crystallization, co-crystallization, centrifugation, decanting, spray drying, fluid bed drying, freeze drying, flash drying, evaporation, wet granulation, compact granulation, agglomeration, milling, sieving, and any combinations thereof.

The obtained purified steviol glycoside(s) can be used as sweeteners, sweetness enhancers, flavor enhancers and flavor modifiers in various food and beverage products. Non-limiting examples of food and beverage products include carbonated soft drinks, ready to drink beverages, energy drinks, isotonic drinks, low-calorie drinks, zero-calorie drinks, sports drinks, teas, fruit and vegetable juices, juice drinks, dairy drinks, yoghurt drinks, alcohol beverages, powdered beverages, bakery products, cookies, biscuits, baking mixes, cereals, confectioneries, candies, toffees, chewing gum, dairy products, flavored milk, yoghurts, flavored yoghurts, cultured milk, soy sauce and other soy base products, salad dressings, mayonnaise, vinegar, frozen-desserts, meat products, fish-meat products, bottled and canned foods, tabletop sweeteners, fruits and vegetables.

Additionally the obtained purified steviol glycoside(s) can be used in drug or pharmaceutical preparations and cosmetics, including but not limited to toothpaste, mouthwash, cough syrup, chewable tablets, lozenges, vitamin preparations, and the like.

The obtained purified steviol glycoside(s) can be used “as-is” or in combination with other sweeteners, flavors, flavor ingredients and food ingredients.

Non-limiting examples of sweeteners include steviol glycosides, stevioside, Rebaudioside A, Rebaudioside B, Rebaudioside C, Rebaudioside D, Rebaudioside E, Rebaudioside F, Rebaudioside G, Rebaudioside H, Rebaudioside I, Rebaudioside J, Rebaudioside K, Rebaudioside L, Rebaudioside M, Rebaudioside N, Rebaudioside O, dulcoside A, steviolbioside, rubusoside, steviolmonoside as well as any other steviol glycoside(s) found in Stevia rebaudiana plant and mixtures thereof, stevia extract, glycosylated steviol glycosides, Luo Han Guo extract, mogrosides, high-fructose corn syrup, corn syrup, invert sugar, fructooligosaccharides, inulin, inulooligosaccharides, coupling sugar, maltooligosaccharides, maltodextrins, corn syrup solids, glucose, maltose, sucrose, lactose, aspartame, saccharin, sucralose, sugar alcohols.

Non-limiting examples of flavors and flavor ingredients include glycosylated steviol glycosides, steviol glycoside(s), mogroside(s), lemon, orange, fruity, banana, grape, pear, pineapple, bitter almond, cola, cinnamon, sugar, cotton candy, vanilla flavors, NSF-01, NSF-02, NSF-03, NSF-04 (available from PureCircle).

Non-limiting examples of other food ingredients include flavors, acidulants, organic and amino acids, coloring agents, bulking agents, modified starches, gums, texturizers, preservatives, antioxidants, emulsifiers, stabilisers, thickeners, gelling agents.

The following examples illustrate various embodiments of the invention. It will be understood that the invention is not limited to the materials, proportions, conditions and procedures set forth in the examples, which are only illustrative.

### EXAMPLE 1

### Preparation of CGTase

A strain of Bacillus stearothermophilus St-100 was inoculated in 2,000 liters of sterilized culture medium containing 1.0% starch, 0.25% corn extract, 0.5% (NH₄)₂SO₄, and 0.2% CaCO₃ (pH 7.0-7.5) at 56° C. for 24 hrs with continuous aeration (2,000 L/min) and agitation (150 rpm). The obtained culture broth was filtered using Kerasep 0.1 μm ceramic membrane (Novasep, France) to separate the cells. The cell-free permeate was further concentrated 2-fold on Persep 10 kDa ultrafilters (Orelis, France). The activity of the enzyme was determined according to Hale, Rawlins (1951). A crude enzyme preparation with activity of about 2 unit/mL was obtained.

### EXAMPLE 2

Preparation of α-glycosyl Reb M

100 g of tapioca starch was suspended in 300 mL of water (pH 6.5). 2 KNU of α-amylase (Termamyl Classic, Novozymes, Denmark) and 30 units of CGTase obtained according to EXAMPLE 1 were added, and the liquefaction of starch was carried out at 80° C. for about one hour to dextrose equivalent about 15. The pH of reaction mixture was adjusted to pH 2.8 by hydrochloric acid and the mixture was boiled at 100° C. during 5 minutes to inactivate the enzymes. After cooling to 65° C., the pH was adjusted to pH 6.0 with sodium hydroxide solution. 10 g of crystalline Rebaudioside M (Reb M; also known as Rebaudioside X) produced by PureCircle Sdn. Bhd. (Malaysia), having water solubility of 0.5 g/L (at 25° C.) and containing 96.97% Reb M and 3.03% Reb D, was dissolved by boiling in 9,000 mL of water (pH was adjusted to pH 6.0) and was added to liquefied starch and stirred until a homogeneous solution was obtained. 200 units of CGTase was added to the solution and the mixture was held at a temperature of 65° C. for 24 hours under continuous agitation. The obtained reaction mixture was heated at 95° C. for 15 minutes to inactivate the enzyme. 20 grams of activated carbon was added and the mixture was heated to 75° C. and held during 30 min. The mixture was filtered and the filtrate was passed through column packed with 1,000 mL Amberlite XAD 7HP macroporous adsorbent resin. The column was washed with 5 volumes of water and 2 volumes of 20% (v/v) ethanol. The adsorbed glycosides were eluted with 50% ethanol. Obtained eluate was passed through columns packed with Amberlite FPC23 (H⁺) and Amberlite FPA51 (OH⁻) ion exchange resins. The ethanol was evaporated and the desalted and decolorized water solution was concentrated at 60° C. under vacuum, then dried into a powder form using laboratory spray dryer. 15.9 grams of α-glycosyl Reb M product was obtained having water solubility of 500 g/L (at 25° C.). The HPLC assay of α-glycosyl Reb M is provided in Table 1.

TABLE 1
HPLC assay of α-glycosyl Reb M

| Compounds | Content, area % |
|---|---|
| Reb M | 6.9 |
| Reb D | 0.3 |
| Mono-glucosyl-Reb M (RebMG1) | 11.8 |
| Di-glucosyl-Reb M (RebMG2) | 7.6 |
| Higher α-1,4-glucosylated derivatives of Reb M | 73.4 |
| Total α-1,4-glucosylated derivatives of Reb M | 92.8 |

### EXAMPLE 3

Hydrolysis of α-glycosyl Reb M

10 g of α-Glycosyl Reb M obtained according to EXAMPLE 2 was dissolved in 90 mL of water. The temperature was maintained at 60° C., and 5 units of glucoamylase (AMG300L, Novozymes), was added and the reaction was continued for 12 hours at 60° C. The obtained reaction mixture was heated at 95° C. for 15 minutes to inactivate the enzyme. 0.5 grams of activated carbon was added and the mixture was heated to 75° C. and held for 30 minutes. The mixture was filtered and the filtrate was diluted with water to 5% solids content and passed through column packed with 1,000 mL Amberlite XAD 7HP macroporous adsorbent resin. The column was washed with 5 volumes of water and 2 volumes of 20% (v/v) ethanol. The adsorbed glycosides were eluted with 50% ethanol. Obtained eluate was passed through columns packed with Amberlite FPC23 (H⁺) and Amberlite FPA51 (OH⁻) ion exchange resins. The ethanol was evaporated and the desalted and decolorized water solution was concentrated at 60° C. under vacuum until 10% solids content. The concentrated solution was left for 24 hrs to crystallize Reb M. The crystals were separated by filtration and dried under vacuum to yield about 4.5 g of Reb M with 99% purity (wt/wt on dried basis).

### EXAMPLE 4

### Evaluation of Reb M

The sensory assessment of Reb M prepared according to EXAMPLE 3, was carried using 600ppm aqueous solution, with 20 panelists. Reb M sample was assessed along with 10% sucrose and 600 ppm commercially available Reb A and Stevioside samples. Based on overall acceptance the most desirable and most undesirable samples were chosen. The results are shown in Table 2.

TABLE 2
Sensory assessment of samples in water system

| Judgment | Stevioside | Reb A | Reb M |
|---|---|---|---|
| Most desirable | 0 | 1 | 19 |
| Most undesirable | 20 | 0 | 0 |
| Sweetness power | 100 | 120 | 170 |
| Comments | Less sweet, | Less sweet, | Sweet, light, |
| | very bitter, | bitter, | soft, round, |
| | astringent, | astringent, | pleasant, |
| | lingering | lingering | similar to |
| | aftertaste, | aftertaste, | sucrose, no |
| | sweetness onset | sweetness onset | lingering |
| | is slow | is slow | aftertaste, |
| | | | sweetness onset |
| | | | is rapid |

As apparent from the results in Table 2, the sweetness quality of the Reb M was rated as most superior.

### EXAMPLE 5

### Low-Calorie Orange Juice Drink

Orange concentrate (35%), citric acid (0.35%), ascorbic acid (0.05%), orange red color (0.01%), orange flavor (0.20%), and different steviol glycosides (0.06%) were blended and dissolved completely in water (up to 100%) and pasteurized. The steviol glycosides were represented by Reb A, Stevioside and Reb M sample, obtained according to EXAMPLE 3.

The sensory evaluations of the samples are summarized in Table 3. The data show that the best results can be obtained by using the Reb M sample. Particularly the drink prepared with Reb M exhibited a rounded and complete flavor profile and mouthfeel.

TABLE 3
Evaluation of orange juice drink samples

| | Comments | | |
|---|---|---|---|
| Sample | Flavor | Aftertaste | Mouthfeel |
| Stevioside | Less sweet, licorice | High bitterness and | Not |
| | notes | aftertaste | acceptable |
| Reb A | Less sweet, off-notes | Bitterness and | Not |
| | | aftertaste | acceptable |
| Reb M | High quality sweetness, | Clean, no bitterness | Full |
| | pleasant taste similar | and no aftertaste | |
| | to sucrose, rounded and | | |
| | balanced flavor | | |

The same method can be used to prepare juices and juice drinks from other fruits, such as apples, lemons, apricots, cherries, pineapples, mangoes, etc.

### EXAMPLE 6

### Zero-Calorie Carbonated Beverage

A carbonated beverage according to formula presented below was prepared.

| Ingredients | Quantity, % |
|---|---|
| Cola flavor | 0.340 |
| ortho-Phosphoric acid | 0.100 |
| Sodium citrate | 0.310 |
| Sodium benzoate | 0.018 |
| Citric acid | 0.018 |
| Steviol glycoside | 0.05 |
| Carbonated water | to 100 |

The steviol glycosides were represented by Reb A, Stevioside and Reb M sample, obtained according to EXAMPLE 3.

The sensory properties were evaluated by 20 panelists. The results are summarized in Table 4.

TABLE 4
Evaluation of zero-calorie carbonated beverage samples

| | Number of panelists detected the attribute | | |
|---|---|---|---|
| Taste attribute | Stevioside | Reb A | Reb M |
| Bitter taste | 20 | 17 | 1 |
| Astringent | 20 | 16 | 0 |
| taste | | | |
| Aftertaste | 20 | 18 | 1 |

Comments

| | | | |
|---|---|---|---|
| Quality of | Clean | Clean | Clean |
| sweet taste | (0 of 20) | (3 of 20) | (20 of 20) |
| Overall | Satisfactory | Satisfactory | Satisfactory |
| evaluation | (0 of 20) | (2 of 20) | (20 of 20) |

The above results show that the beverages prepared using Reb M sample possessed the best organoleptic characteristics.

### EXAMPLE 7

### Diet Cookies

Flour (50%), margarine (30%) fructose (10%), maltitol (8%), whole milk (1%), salt (0.2%), baking powder (0.15%), vanillin (0.1%) and different steviol glycosides (0.06%) were kneaded well in dough-mixing machine. The obtained dough was molded and baked in oven at 200° C. for 15 minutes. The steviol glycosides were represented by Reb A, Stevioside and Reb M sample, obtained according to EXAMPLE 3.

The sensory properties were evaluated by 20 panelists. The best results were obtained in samples prepared with Reb M. The panelists noted rounded and complete flavor profile and mouthfeel in cookies prepared with Reb M.

It is to be understood that the foregoing descriptions and specific embodiments shown herein are merely illustrative of the best mode of the invention and the principles thereof, and that modifications and additions may be easily made by those skilled in the art without departing for the spirit and scope of the invention, which is therefore understood to be limited only by the scope of the appended claims.

1. A process for producing terpenoid glycoside comprising the steps of:
a. producing α-glycosyl derivative of terpenoid glycoside having at least one α-glycosyl residue;
b. hydrolyzing the produced α-glycosyl derivative of terpenoid glycoside to obtain the terpenoid glycoside.

2. The process of claim 1 further comprising the step of:
c. purifying the obtained terpenoid glycoside.

3. The process of claim 1 wherein step (a) the terpenoid glycoside is synthesized by a recombinant microorganism.

4. The process of claim 1 wherein step (a) the terpenoid glycoside is synthesized by at least one biocatalyst.

5. The process of claim 1 wherein step (a) the terpenoid glycoside is synthesized by at least one enzyme.

6. The process of claim 1 wherein step (a) occurs in recombinant microorganism.

7. The process of claim 1 wherein step (a) occurs outside of recombinant microorganism.

8. The process of claim 1 wherein step (a) occurs on the surface of recombinant microorganism.

9. The process of claim 1 wherein step (b) occurs outside of recombinant microorganism.

10. The process of claim 1 wherein step (b) occurs by contacting α-glycosyl derivative of terpenoid glycoside with at least one biocatalyst.

11. The process of claim 1 wherein step (b) occurs by contacting α-glycosyl derivative of terpenoid glycoside with at least one enzyme.

12. The process of claim 1 wherein the terpenoid glycoside is selected from the group consisting of stevia extract, steviol glycosides, stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, dulcoside A, steviolbioside, rubusoside, glycosylated steviol glycosides, glucosylated steviol glycosides as well as any other steviol glycoside(s) found in Stevia rebaudiana plant and mixtures thereof.

13. The process of claim 1 wherein the terpenoid glycoside is selected from the group consisting of Luo Han Guo extract, mogrol glycosides, mogrosides, mogroside mogroside II, mogroside II B, mogroside II E, mogroside III, mogroside III A2, mogroside IV, mogroside V, mogroside VI, neomogroside, grosmomoside siamenoside I, 7-oxo-mogroside II E, 11-oxo-mogroside A1, 11-deoxy-mogroside III, -oxomogroside IV A, 7-oxo-mogroside V, 11-oxo-mogroside V, as well as any other mogrol glycoside(s) found in Siraitia grosvenorii plant and mixtures thereof.

14. A flavor composition comprising terpenoid glycoside of claim 1 and at least one additional flavoring agent selected from the group consisting of, lemon, berry, orange, fruit, banana, grape, pear, pineapple, mango, bitter almond, cola, cinnamon, sugar, cotton candy, vanilla, terpenoid glycosides, NSF01, NSF02, NSF03, NSF04 and combination thereof.

15. A food ingredient comprising terpenoid glycoside of claim 1 and at least one additional food ingredient selected from the group consisting of acidulants, organic and amino acids, coloring agents, bulking agents, modified starches, gums, texturizers, preservatives, antioxidants, emulsifiers, stabilisers, thickeners, gelling agents, and combination thereof.

16. A food, beverage, cosmetic, pharmaceutical product or other consumable comprising terpenoid glycoside of claim 1.
